(19) United States
(12) Patent Application Publication
(10) Pub. No.: US 2006/0238131 A1
(43) Pub. Date: Oct. 26, 2006

(54) Power supply control apparatus for heater of fixing unit

(75) Inventor: Jong-in Hwang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/371,933

(22) Filed: Mar. 10, 2006

(30) Foreign Application Priority Data
Apr. 21, 2005 (KR) 2005-33041

(51) Int. Cl. H05B 39/04

(52) U.S. Cl. 315/106

(57) ABSTRACT

A power supply control apparatus for a heating element heating a fixing roller. A plurality of heating elements generate a predetermined heat using AC power. A plurality of switching parts switch the AC power to the plurality of heating elements, and a controlling part controls the plurality of switching parts such that the AC power is not simultaneously supplied to the plurality of heating elements. The power supply control apparatus ensures image fixation as effectively as a single heater lamp having a large capacity and reduces a flicker problem associated with a rush current input to the heater elements.

### CROSS-REFERENCE TO RELATED APPLICATIONS

This application claims the benefit of Korean Patent Application No. 2005-33041, filed Apr. 21, 2005, in the Korean Intellectual Property Office, the disclosure of which is incorporated herein by reference.

### BACKGROUND OF THE INVENTION

1. Field of the Invention

Aspects of the present invention relate to a power supply control apparatus, and more particularly, to a power supply control apparatus for a heater of a fixing unit of an electrophotographic printer.

2. Description of the Related Art

Generally, an image formation device such as an electrophotographic printer has a photosensitive medium, a developing unit, a transferring unit and a fixing unit. The fixing unit transfers an image formed with a developing agent at the photosensitive medium by the developing unit, to the recording paper, and the fixing unit fixes the image transferred on the recording paper.

A conventional fixing unit is designed to heat a surface of a fixing roller separately installed from a transferring roller, at a predetermined temperature, so that the recording paper entering through the transferring roller can be pressurized and advanced. There is a generally applied heater lamp such as a halogen lamp, or an e-coil as a heating element for heating the surface of the fixing roller at the predetermined temperature.

FIG. 1 is a block diagram showing an example of the power supply control apparatus for the heater lamp used for a conventional fixing unit.

Referring to FIG. 1, a conventional power supply control apparatus 100 for a conventional heater lamp includes a power inputting part 110, one heater lamp 120, a switching part 130, and a controlling part 140. The heater lamp 120 is driven to be heated by AC supplied through the power inputting part 110 and installed inside a fixing roller (not shown), thereby heating the fixing roller at a predetermined temperature. The switching part 130 is mounted between the power inputting part 110 and the heater lamp 120. The switching part 130 controls the supply of AC power to the heater lamp 120 according to a heater lamp control signal of the controlling part 140 and thus controls on and off of the heater lamp 120.

As an output velocity a recording paper in the image formation apparatus increases, greater heat is needed for the fixing unit, in order to more promptly fix a transferred developing agent on the recording paper. Accordingly, it is necessary to use the heater lamp having a large capacity to increase the output velocity of the recording paper. However, the use of a large capacity heater lamp causes the following problems.

The heater lamp consumes the most current when power is initially supplied, that is, at a starting point. After a predetermined time, a high current is not required to drive the heater lamp. The reason is that when a filament sealed in the heater lamp is at a low temperature due to, for example, absence of power, a resistance is small and therefore current flowing through the filament increases. When power is supplied and the heater lamp is heated, the resistance increases and the current flow is small. The maximum current flowing through the heater lamp when the heater lamp is at a low temperature is ‘rush current’, and the rush current increases as the heater lamp has a larger power consumption.

Accordingly, the power is temporarily reduced to a peripheral circuit of the heater lamp due to high rush current generated when the heater lamp with high power consumption is initially driven. Such a phenomenon is called ‘flicker,’ and causes malfunctions of electronic devices of the peripheral circuit.

The heater lamp capacity and the flicker impact are a trade-off relation and therefore, the larger the capacity of the heater lamp, the more severely the peripheral circuit is influenced by the flicker phenomenon. That is, a negative impact on the peripheral circuit is proportional to the capacity of the heater lamp. Sometimes, where the heater lamp has a large capacity, for example, over 900 W, an amount of flicker causes unacceptable disturbances in the peripheral circuit.

### SUMMARY OF THE INVENTION

An aspect of the present invention is to solve at least the above and/or other problems and disadvantages of the related art and to provide at least the advantages described below. Accordingly, an aspect of the present invention is to provide a power supply control apparatus to be used for a heating element which has less flicker effects and ensures a same fixation as the heater lamp with the large capacity.

Additional aspects and/or advantages of the invention will be set forth in part in the description which follows and, in part, will be obvious from the description, or may be learned by practice of the invention.

In order to achieve the above-described aspects of the present invention, there is provided a power supply control apparatus for a heating element heating a fixing roller, comprising: a power inputting part receiving an external AC power; a plurality of heating elements generating a predetermined heat by the AC power received through the power inputting part and heating the fixing roller; a plurality of switching parts controlling supply of the AC power to the plurality of heating elements; and a controlling part controlling the plurality of switching parts such that the AC power input through the power inputting part is not simultaneously supplied to the plurality of heating elements.

The plurality of heating elements comprises a first heater lamp and a second heater lamp, each having a first end connected to a first power inputting terminal of the power inputting part and the a second end connected to a respective one of the plurality of switching parts.

The plurality of switching parts comprises a first switching part and a second switching part, each having an input end connected to a second power inputting terminal of the power inputting part and an output end connected to a respective one of the first and second heater lamps.

The first and second heater lamps may be halogen lamps. The controlling part turns on the first heater lamp when a phase of the AC power is 0° to 180°, and turns on the second heater lamp when the phase of the AC power is 180° to 360°.

The power supply control apparatus further comprises a sensing part sensing a current temperature of the fixing roller. When the sensed current temperature of the fixing roller is equal to or less than a predetermined reference temperature in a printing standby mode, the controlling part controls the switching parts to drive the heating elements in a preset driving interval.

The power supply control apparatus may further comprise a memory storing the reference temperature.

The controlling part controls the switching parts to turn the heating elements off for a predetermined time after the driving interval of the heating elements.

The predetermined time which the heating elements are turned off is at least 3 times as much as the driving interval of the heating elements.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an example of a conventional power supply control apparatus with respect to a heater lamp used for a fixing unit,

FIG. 2 is a circuit diagram of the power supply control apparatus for a heating element used for the fixing unit according to an embodiment of the present invention,

FIGS. 3A, 3B and 3C are provided to explain the controlling part of FIG. 2 controlling the first and second heater lamps shown in FIG. 2, and

FIGS. 4A and 4B are provided to explain the controlling part of FIG. 2 variably controlling a repetition cycle of driving intervals of the first and second heater lamps in a printing standby mode.

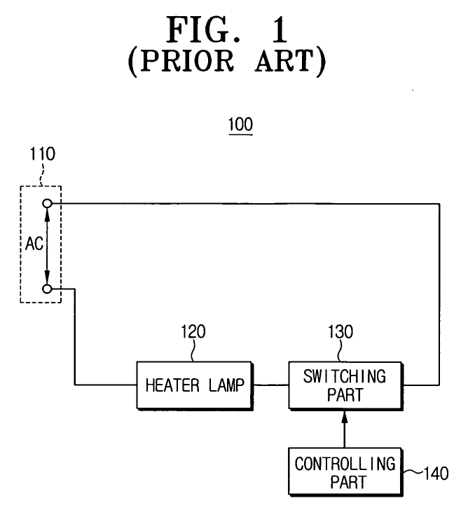

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

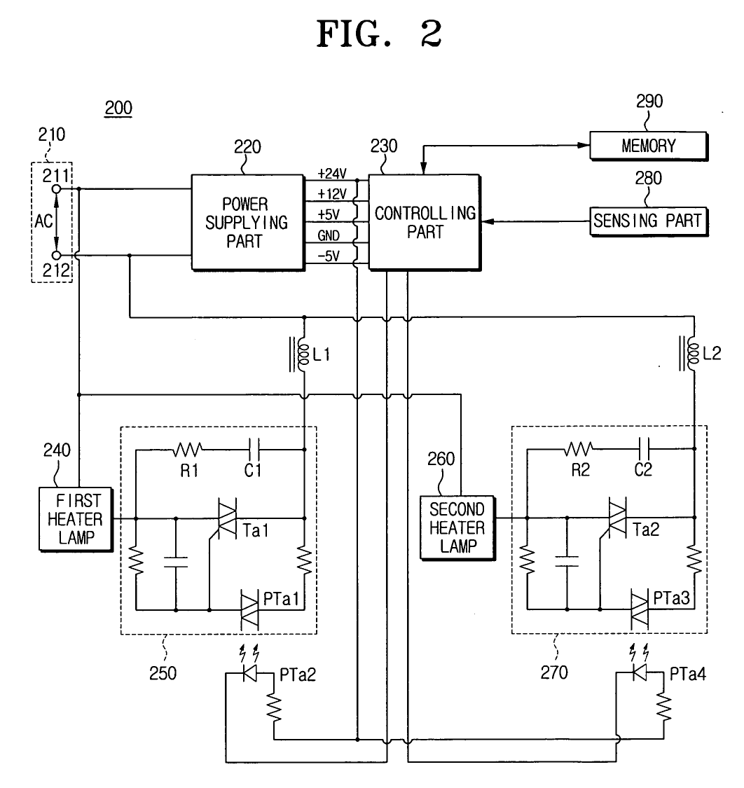

FIG. 2 is a circuit diagram of a power supply control apparatus 200 for a heating element used for a fixing unit according to an embodiment of the present invention.

Referring to FIG. 2, the power supply control apparatus 200 includes a power inputting part 210, a power supplying part 220, a controlling part 230, a first heater lamp 240, a second heater lamp 260, a first switching part 250, a second switching part 260, a sensing part 280, and a memory 290.

The power inputting part 210 is supplied with AC power, e.g., 110V, 220V, through a first power inputting terminal 211 and a second power inputting terminal 212 and supplies the AC power to the power supply 220, the first heater lamp 240, the second heater lamp 260, the first switching part 250, and the second switching part 270.

The power supplying part 220, which may be a Switching Mode Power Supply (SMPS), converts AC power input through the power inputting part 210, thus generating various voltages as needed, such as for example, +24V, +12V, +5V, and −5V and supplies the voltages to an image formation apparatus.

The first switching part 250 is connected between the first heater lamp 240 and the second power inputting terminal 212 and switches on and off according to a heater lamp control signal of the controlling part 230. More specifically, the first switching part 250 comprises a first loop including a serially connected capacitor (C1) and a resistance (R1), a triac (Ta1) parallel connected with the first loop, and a photo triac (Pta1) provided to trigger a gate terminal of the triac (Ta1). A luminous diode (PTa2) paired with the photo triac (PTa1) is provided to radiate according to the heater lamp control signal of the controlling part 230.

Accordingly, the first switching part 250 connects or disconnects the first heater lamp 240 and the inductor (L1), connected with the second power inputting terminal 212, by the photo triac (Pta1) turning on and off according to radiation or non-radiation of the luminous diode (PTa2) according to the heater lamp control signal. The resistance (R1), the capacitor (C1), and the inductor (L1) provide noise removal and frequency compensation.

The switching part 270 is connected between the second heater lamp 260 and the second power inputting terminal 212 and switches on and off according to the heater lamp control signal of the controlling part 230, thus electrically connecting and disconnecting an inductor (L2), connected with the second power inputting terminal 212, and the second heater lamp 260. A capacitor (C2), a resistance (R2), a triac (Ta2), a photo triac (PTa3), a luminous diode (PTa4), and the inductor (L2) of the second switching part 270 correspond to the capacitor (C1), the resistance (R1), the triac (Ta1), the photo triac (PTa1), the luminous diode (PTa2), and the inductor (L1) of the first switching part 250, respectively, and operate in a same manner.

The first heater lamp 240 and the second heater lamp 260 may be installed at a predetermined position, for example, inside the fixing roller, to heat the fixing roller (not shown).

More specifically, the first heater lamp 240 has a first end connected to the first power inputting terminal 211, and a second end connected to the first switching part 250. The first heater lamp 240 is supplied with AC power from the power inputting part 210 according to the on and off switching operation of the first switching part 250, and generates high-temperature heat.

The second heater lamp 260 has a first end connected to the first power inputting terminal 211, and a second end connected to the second switching part 270, to be parallel connected with the first heater lamp 240. The second heater lamp 260 is supplied with AC power from the power inputting part 210 according to the on and off switching operation of the second switching part 270, and generates high-temperature heat.

The first heater lamp 240 and the second heater lamp 260 may be halogen lamps.

The sensing part 280 includes a temperature sensing device, such as a thermistor, senses the temperature of the fixing roller (not shown), and provides the sensed result to the controlling part 230. The memory 290 stores an optimum temperature range of the fixing roller preset for each printing mode. In particular, the memory 290 stores a target control temperature with respect to the fixing roller in a printing standby mode and a reference temperature for the fixing roller for driving the first and second heater lamps 240 and 260 during a preset lamp driving interval.

The controlling part 230 controls the first and second switching parts 250 and 260 according to the preset optimum temperature of the fixing roller for each printing mode and the current temperature of the fixing roller (not shown) sensed through the sensing part 280, to control on and off of the first and second heater lamps 240 and 260, such that the fixing roller stays within the optimum temperature range.

If a plurality of heater lamps with mid-capacity are simultaneously turned on, larger power is required than using one heater lamp with a large capacity, such that a tolerance to flicker deteriorates. Accordingly, the controlling part 230 according to an embodiment of the present invention controls the first and second heater lamps 240 and 260 not to be simultaneously turned on.

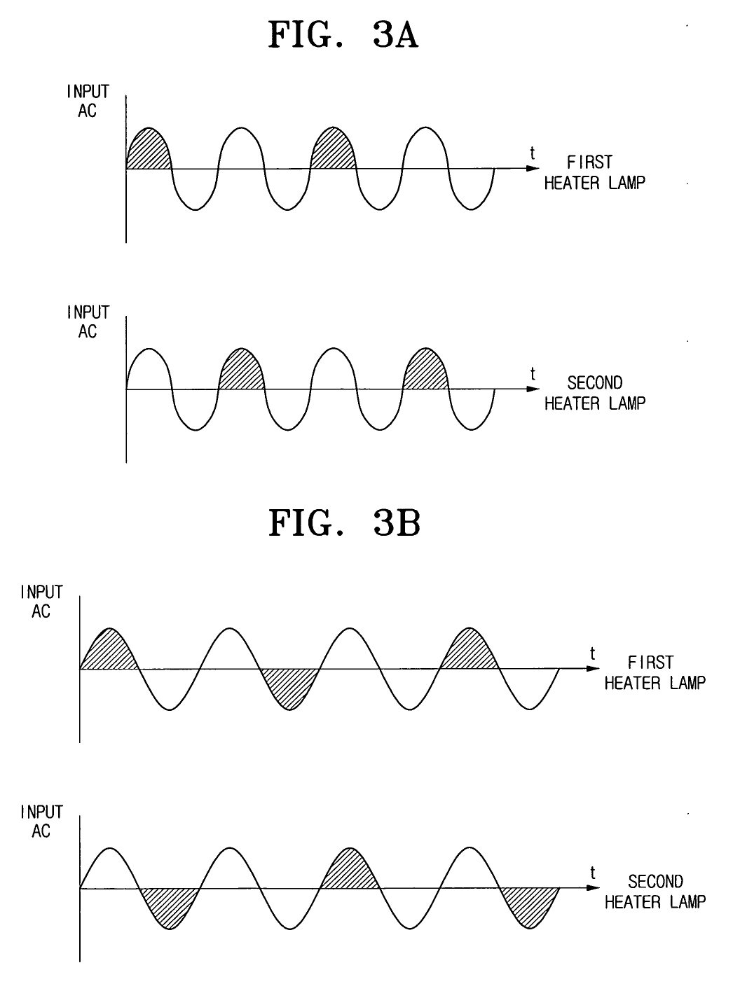

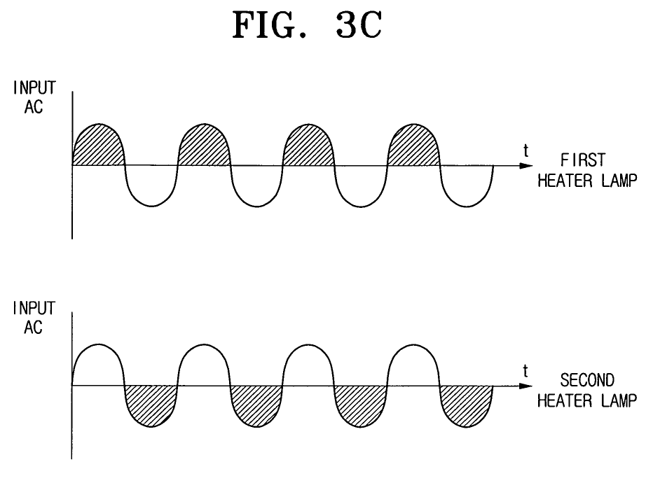

Hereinafter, with reference to FIGS. 3A, 3B and 3C a method of controlling power so that the first and second heater lamps 240 and 260 are not turned on at the same time will be described.

FIGS. 3A through 3C represent waveforms of the input AC power. The controlling part 230 controls the first and second heater lamps 240 and 260 to be turned on as indicated by obliquely lined areas of the input AC power waveforms, such that the first and second heater lamps 240 and 260 are not simultaneously switched on.

FIG. 3A shows a 25% chopping control of the first and second heater lamps 240 and 260; FIG. 3B shows 30% chopping control of the first and second heater lamps 240 and 260; and FIG. 3C shows 50% chopping control of the first and second heater lamps 240 and 260.

The waveform of the input AC power is divided into 2 phases, approximately 0° to 180° and 180° to 360°, and the first and second heater lamps 240 and 260 are turned on and off accordingly. However, various changes in form and details may be made therein provided that the first and second eater lamps 240 and 260 are controlled not to be on simultaneously.

According to the embodiment shown in FIG. 2, it is described that two heating elements are provided, that is, the first and second heater lamps 240 and 260. However, this should not be construed as limiting and therefore, the present invention may include more than 2 heating elements, and provided that the heating elements are controlled not to be turned on simultaneously.

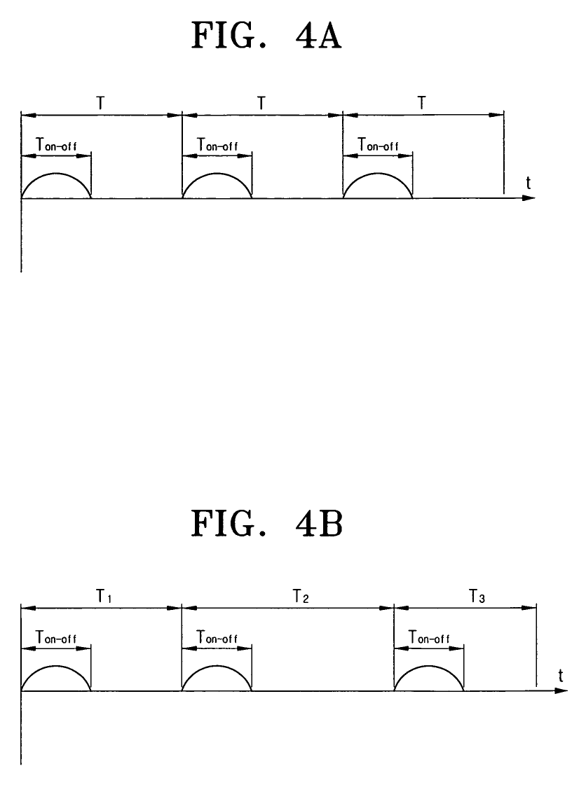

FIGS. 4A and 4B are provided to explain the controlling part of FIG. 2 variably controlling a repetition cycle of driving section by chopping control on the first and second heater lamps in a printing standby mode.

The temperature of the heater lamp heating the fixing roller may drop more than necessary, in the case that the fixing roller is not maintained at a uniform temperature in a printing standby mode. It takes much time to reheat the fixing roller to a temperature required in a printing standby mode, thus inconveniencing users. Accordingly, when the heater lamp receives the AC power again, with the temperature of filament of the heater lamp excessively decreased, as mentioned above, rush current occurs, such that the voltage supplied to a peripheral device of the image formation device is reduced, causing ‘flicker.’

As illustrated in FIG. 4A, the lamp driving interval (Ton-off) by on and off chopping control of the heater lamp in a printing standby mode is provided to each heater lamp. The lamp driving interval (Ton-off) is repeated in a fixed control cycle (T) and heated, such that the fixing roller and the heater lamp stay within a predetermined range.

However, in a conventional case that on and off chopping control of the heater lamp is repeated according to the fixed control cycle (T) regardless of the current temperature of the fixing roller, the heater may be driven when the fixing roller is maintained at a predetermined temperature, and unnecessary power consumption may occur.

Accordingly, the embodiment of the present invention variably controls according to the current temperature of the fixing roller, instead of repeating the lamp driving interval (Ton-off) by on and off chopping control of the heater lamp in a printing standby mode, in a fixed cycle.

The controlling part 230 according to the embodiment shown in FIG. 2 compares the current temperature of the fixing roller received through the sensing part 280 in a printing standby mode with the preset reference temperature of the memory 290. When the current temperature of the fixing roller falls to or below the reference temperature, on and off chopping control is performed, such that the first and second heater lamps 240, 260 are not turned on simultaneously during the preset lamp driving section (Ton-off). The reference temperature is set to be 20 to 5° lower than the control target temperature of the fixing roller in a printing standby mode and the controlling part 230 may experimentally measure a time for the reference temperature of the fixing roller to reach the control target temperature when on and off control of the heater lamp is performed.

FIG. 4B illustrates the controlling part 230 starting on and off chopping control of the first and second heater lamps 240 and 260 to vary a beginning of the lamp driving interval (Ton-off) by different values, e.g., T1, T2 and T3. Accordingly, time of driving the first and second heater lamps 240, 260 is minimized according to the current temperature of the fixing roller, and accordingly unnecessary power consumption is prevented and flicker is reduced.

If the heater lamp is unconditionally driven by on and off chopping control of the heater lamp whenever the current temperature of the fixing roller falls to or below the reference temperature, at a low external temperature, the driving time of the heater lamp may be excessively lengthened. Accordingly, more power consumption is required than the conventional method and the flicker would become more severe.

Accordingly, the controlling part 230 controls the first and second switching parts 250, 260 such that the first and second heater lamps 240, 260 are turned off, for time 3 to 5 times longer than the lamp driving interval (Ton-off) after the driving of the first and second heater lamps 240, 260 in a printing standby mode. By doing so, the heater lamps are prevented from being excessively driven.

As mentioned above, the power supply control apparatus according to the embodiment of the present invention ensures a good image fixation similar to using a heater lamp with a large capacity and the flicker problem becomes less intrusive.

The cycle of repeating the lamp driving section in a printing standby mode is varied according to the current temperature of the fixing roller, such that the time of driving the heater lamps is minimized and unnecessary power consumption is prevented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A power supply control apparatus for a heating element heating a fixing roller, the power supply control apparatus comprising:
a plurality of heating elements generating a predetermined heat to heat the fixing roller using an input AC power;
a plurality of switching parts controlling the AC power to the plurality of heating elements; and
a controlling part controlling the plurality of switching parts such that the AC power is not simultaneously supplied to all of the plurality of heating elements.

2. The power supply control apparatus as claimed in claim 1, wherein the plurality of heating elements comprise a first heater lamp and a second heater lamp, each having a first end connected to a first power inputting terminal and a second end connected to a respective one of the plurality of switching parts.

3. The power supply control apparatus as claimed in claim 2, wherein the plurality of switching parts comprise a first switching part and a second switching part, each having a first end connected to a second power inputting terminal and a second end connected to a respective second end of one of the first and second heater lamps.

4. The power supply control apparatus as claimed in claim 2, wherein the first and second heater lamps comprise a halogen lamp or an e-coil.

5. The power supply control apparatus as claimed in claim 2, wherein the controlling part turns on the first heater lamp when the phase of the AC power is 0° to 180°, and turns on the second heater lamp when the phase of the AC power is 180° to 360°.

6. The power supply control apparatus as claimed in claim 1, further comprising:
a sensing part sensing a current temperature of the fixing roller, wherein:
when the sensed current temperature of the fixing roller is equal to or less than a predetermined reference temperature in a printing standby mode, the controlling part controls the switching parts to drive the heating elements during a preset driving interval.

7. The power supply control apparatus as claimed in claim 6, wherein the controlling part controls the switching parts to turn the heating elements off for a predetermined time after the driving interval of the heating elements.

8. The power supply control apparatus as claimed in claim 7, wherein the predetermined time which the heating elements are turned off is at least 3 times as long as the driving interval of the heating elements.

9. The power supply control apparatus as claimed in claim 6, further comprising a memory storing the reference temperature.
